(19) United States
(12) Patent Application Publication
(10) Pub. No.: US 2017/0070665 A1
(43) Pub. Date: Mar. 9, 2017

(54) ELECTRONIC DEVICE AND CONTROL METHOD USING ELECTRONIC DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XIN LU, Shenzhen (CN); YU-CUI ZHOU, Shenzhen (CN)

(21) Appl. No.: 14/886,737

(22) Filed: Oct. 19, 2015

(30) Foreign Application Priority Data
Sep. 7, 2015 (CN) 201510561018.3

(51) Int. Cl. H04N 5/232; G06F 3/01; G06F 1/16; G06F 3/16

(52) U.S. Cl. CPC H04N 5/23216; H04N 5/23293; G06F 3/167; G06F 3/017; G06F 1/1686

(57) ABSTRACT

An electronic device includes a display device, a rotatable and retractable camera, at least one processor, and a storage device storing one or more programs. When a control system is activated, the camera is extended outwardly from the electronic device to enter into a working state; and rotation angle and tracking commands can be generated and applied through a user interface and from gestures discernible in images which are captured.

### CROSS-REFERENCE TO RELATED APPLICATIONS

This application claims priority to Chinese Patent Application No. 201510561018.3 filed on Sep. 7, 2015, the contents of which are incorporated by reference herein.

### FIELD

The subject matter herein generally relates to electronic control mechanisms.

### BACKGROUND

Electronic devices (for example, mobile phones or tablet computers) have been widely used for taking pictures. In order to take a photo, a user generally makes use of the display screen.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device.

FIG. 2 is a block diagram of an embodiment of function modules of a control system in the electronic device of FIG. 1.

FIG. 3 is a diagrammatic view of a first embodiment of a user interface of setting a rotation angle in the electronic device of FIG. 1.

FIG. 4 is a diagrammatic view of a second embodiment of a user interface of setting a rotation angle in the electronic device of FIG. 1.

FIG. 5 is a diagrammatic view of a third embodiment of a user interface of setting a rotation angle in the electronic device of FIG. 1.

FIG. 6 is a diagrammatic view of an embodiment of a user interface in the electronic device of FIG. 1.

FIG. 7 is a flowchart of an embodiment of a control method using the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™ flash memory, and hard disk drives. The term “comprising” means “including, but not necessarily limited to”; it specifically indicates open-ended inclusion or membership in a so-described combination, group, series and the like.

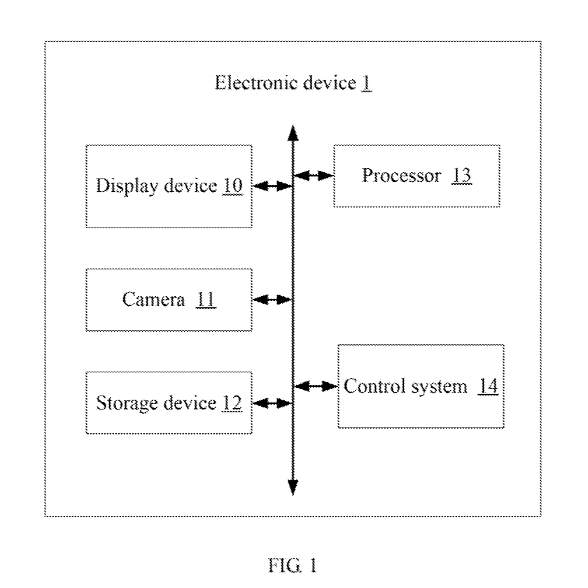

FIG. 1 shows an exemplary embodiment of an electronic device. In at least one embodiment as shown in FIG. 1, an electronic device 1 includes, but is not limited to, a display device 10, a camera 11, a storage device 12, at least one processor 13, a control system 14, and a variety of control circuits (set within the electronic device 1, and not shown in FIG. 1). The electronic device 1 can be a mobile phone, a tablet computer, a personal computer, or any other electronic device having the camera 11. FIG. 1 illustrates only one example of the electronic device 1, other examples can include more or fewer components than illustrated, or have a different configuration of the various components in other embodiments.

In at least one embodiment, the display device 10 can be a touch screen, which supports multi-touches, such as resistive touch screens or capacitive touch screens. The display device 10 can display images. In some embodiments, the display device 10 can be placed in front of the electronic device 1.

In at least one embodiment, the camera 11 can capture images and send the images to the display device 10 via a signal transmission line. The camera 11 can be a rotatable and retractable camera. In some embodiments, the camera 11 can rotate 360 degrees when extended from the electronic device 1. Rotatable and retractable cameras are well known to prior art, and are not described here.

In at least one embodiment, the storage device 12 can include various types of non-transitory computer-readable storage mediums. For example, the storage device 12 can be an internal storage system, such as a flash memory, a random access memory (RAM) for temporary storage of information, and/or a read-only memory (ROM) for permanent storage of information. The storage device 12 can also be an external storage system, such as a hard disk, a storage card, or a data storage medium.

In at least one embodiment, the at least one processor 13 can be a central processing unit (CPU), a microprocessor, or other data processor chip. The at least one processor 13 is connected to the display device 10, the camera 11, the storage device 12, and the control system 14.

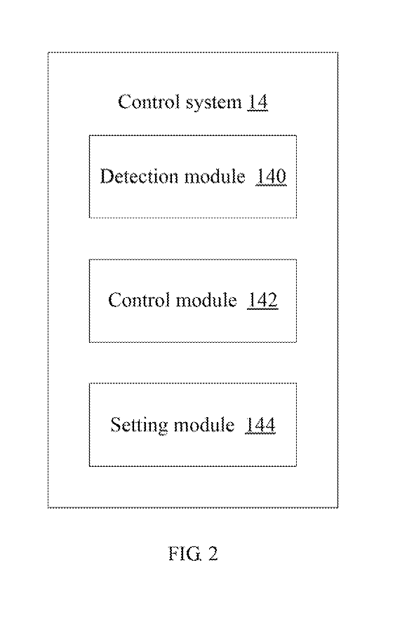

FIG. 2 shows an exemplary embodiment of function modules of the control system 14. In at least the one embodiment shown in FIG. 2, the control system 14 can include a detection module 140, a control module 142, and a setting module 144. The function modules 140, 142, and 144 can include computerized codes in the form of one or more programs which are stored in the storage device 12 of the electronic device 1. The at least one processor 13 of the electronic device 1 executes the computerized codes to provide functions of the function modules 140, 142, and 144.

In at least one embodiment, the detection module 140 can send a signal to the control module 142, in response to a detection of the activating or the closing of the control system 14.

In some embodiments, the display device 10 can display an application icon (not shown) in accordance with the control system 14. When a user touches the application icon for a first time, the control system 14 is activated, causing the detection module 140 to send a signal of the control system 14 being activated. When a user touches the application icon for a second time, the control system 14 can be closed causing the detection module 140 to send a signal of the closing of the control system 14.

In at least one embodiment, the control module 142 can control the camera 11 to perform predetermined actions according to the signals from the detection module 140.

In some embodiments, when the detection module 140 sends a signal of the control system 14 being activated, the control module 142 can control the camera 11 to extend or extend outwardly from the electronic device 1 to enter into a working state. The predetermined actions may include for example rotating according to a preset rotation angle, and/or capturing images. When the detection module 140 sends a signal of the control system 14 being closed, the control module 142 can control the camera 11 to stop working. At the same time, the control module 142 can control the camera 11 to be retracted into the electronic device 1.

In at least one embodiment, the setting module 144 can preset a rotation angle and generate rotation angle commands to control the camera 11 to rotate the preset rotation angle.

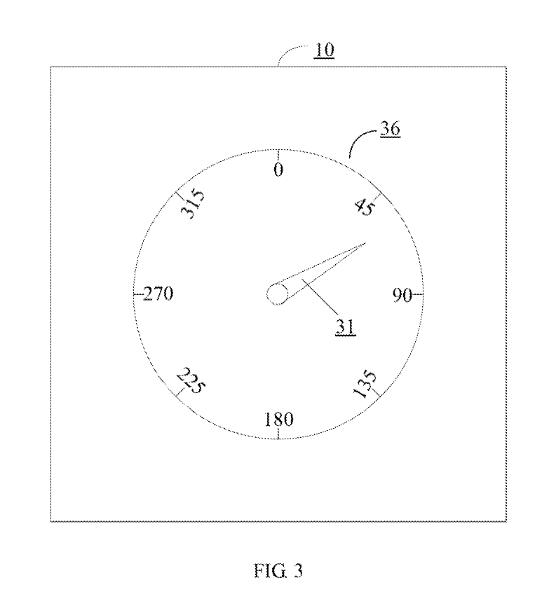

In one embodiment, the display device 10 can display a user interface 36 in accordance with the control system 14. The user can preset the rotation angle through the user interface 36. The user interface 36 may be as shown in FIGS. 3-5.

In FIG. 3, the display device 10 is displaying a compass. On the compass, a circle represents 360 equidistant degrees. The user can move a pointer 31 of the compass to preset a position. The setting module 144 can generate a rotation angle command by analyzing a relationship between positions and rotation angle commands stored in the storage device 12.

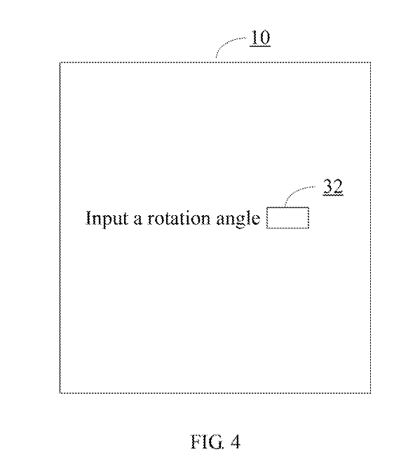

In FIG. 4, the display device 10 is displaying an input box 32. The user can preset and input a value on the input box 32 directly. The setting module 144 can generate a rotation angle command by analyzing a relationship between values and rotation angle commands stored in the storage device 12.

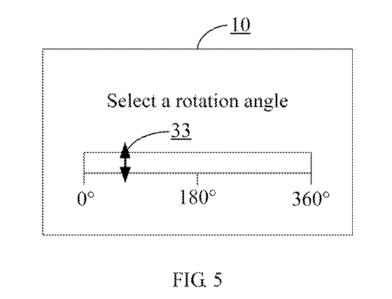

In FIG. 5, the display device 10 is displaying a control bar 33. On the control bar 33, a terminal of the control bar represents 360 degrees. The user can preset a position by slipping the control bar 33 to a certain distance. The setting module 144 can generate a rotation angle command by analyzing a relationship between distances and rotation angle commands stored in the storage device 12.

In another embodiment, the user can preset the rotation angle through voice command. The setting module 144 can receive voice command from the user and generate rotation angle commands accordingly. For example, when user says “rotate 30 degrees”, the setting module 144 can generate a rotation angle command to control the camera 11 to rotate in a predetermined direction 30 degrees based on the “rotate 30 degrees” voice command. In some embodiments, the predetermined direction can be a default. In some embodiments, the predetermined direction can be preset by the user.

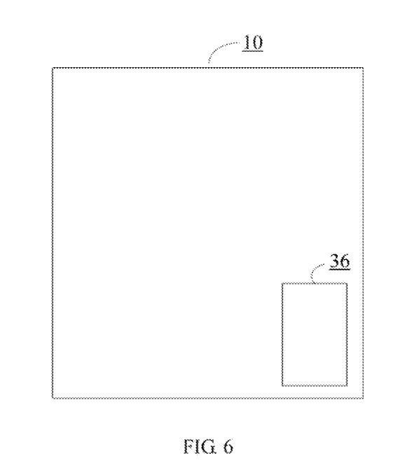

In other embodiments, the user can preset the rotation angle at any time when the user views the images displayed on the display device 10. A small size user interface 36 can be displayed on the display device 10, as shown in FIG. 6. That is to say, the display device 10 can display the images and the small size user interface 36 simultaneously. The user can reset the rotation angle for the camera 11 while viewing the images. The small size user interface 36 can be displayed anywhere, for example, displayed at the bottom of the right hand side of the display device 10. The size of the small size user interface 36 should not affect the user viewing the images.

In at least one embodiment, the setting module 144 can also preset a rotation direction and generate rotation direction commands to control the camera 11 to rotate the required preset rotation direction. The preset rotation direction can be clockwise rotation, or counterclockwise rotation. That is to say, the setting module 144 can generate rotation direction commands to control the camera 11 to rotate clockwise 360 degrees, or rotate counterclockwise through 360 degrees.

In at least one embodiment, the setting module 144 can also preset a function of continuous shooting. If the user opens the function of continuous shooting, the camera 11 can capture a predetermined number (for example, three) of the images within a predetermined time period (for example, one second). If the user closes the function of continuous shooting, the camera can capture one image at a time.

The setting module 144 is provided by way of example, the embodiments described above are not to be limited, and the setting module 144 can preset combinations of features which are each presentable.

In at least one embodiment, the control module 142 can also control the camera 11 to rotate the preset rotation angle to capture images after receiving the rotation angle commands.

The control module 142 can control the camera 11 to rotate through the preset rotation angle in the preset rotation direction. For example, if the preset rotation direction is clockwise, the control module 142 can control the camera 11 to rotate the preset angular rotation clockwise. If the preset rotation direction is counterclockwise, the control module 142 can control the camera 11 to rotate the preset angular rotation counterclockwise.

In at least one embodiment, the control module 142 can further control the camera 11 to perform predetermined actions according to gestures appearing in the captured images.

When the camera 11 captures images, the display device 10 displays the images synchronously. The control module 142 can generate control commands by analyzing a gesture which is apparent in the images. For example, if the image shows a gesture of “scissor hands” or “OK”, the control module 142 analyzes and controls the camera 11 to take at least one picture. If the image shows a gesture of “rotation”, the control module 142 analyzes and controls the camera 11 to rotate. The gestures of “scissor hands” or “OK” or “rotation” can be stored in the storage device 12. The storage device 12 can store a relationship between the detected gestures and the control commands.

In at least one embodiment, the control module 142 can further control the camera 11 to rotate by analyzing a relative movement of a target in the images. That is to say, the control module 142 can control the camera 11 to track the target automatically.

Specifically, the camera 11 takes a first picture and then a second picture, both including the target, within a predetermined time period (for example, 0.1 second). The control module 142 firstly determines whether the target is moving by analyzing a position of the target in the first picture and in the second picture. The control module 142 determines whether the target is moving by recognizing a face of the target, in the case of images of a human target. Face recognition is very well known technology, and is not described here.

For example, if a position of the target in the first picture is center and a position of the target in the second picture is left, the control module 142 determines that the target is moving to the left. The control module 142 controls the camera 11 rotate left to centralize the target in a next image. If the positions of the target in the first picture and in the second picture are the same, the control module 142 determines that the target is not moving, and the camera 11 may capture images without rotating.

The control system 14 can not only control the camera 11 to rotate to track the target according to the relative movement of the target in the images but can also control the camera 11 to rotate to track the target according to a motion vector set by the target. The control system 14 is provided by way of examples; the embodiments described above are not to be limited.

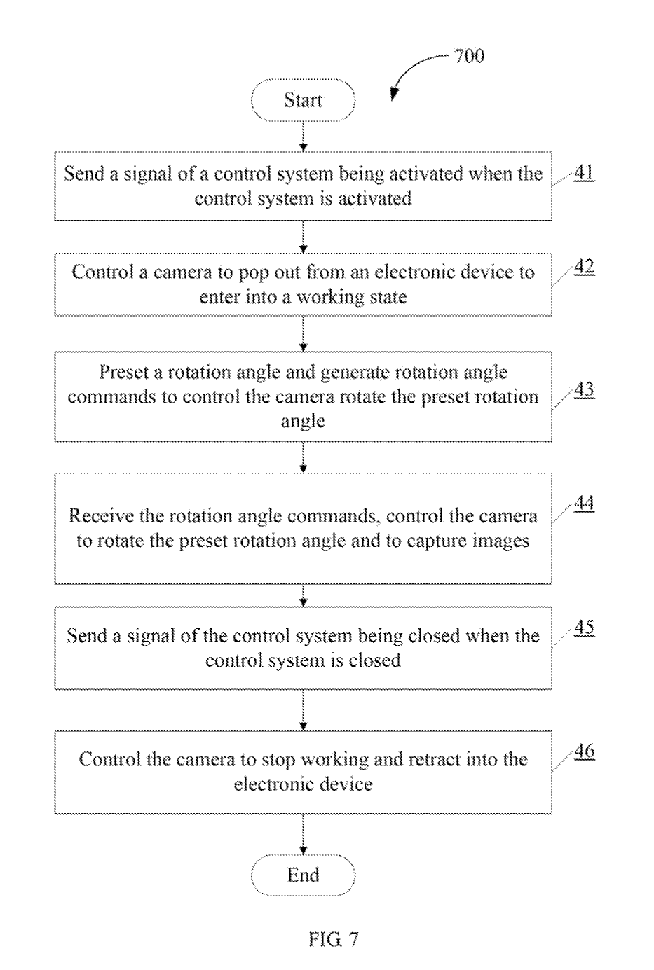

FIG. 7 illustrates a flowchart in accordance with an exemplary embodiment. An exemplary method 700 is provided by way of example, as there are a variety of ways to carry out the method. The exemplary method 700 described below can be carried out using the configurations illustrated in FIG. 1 and FIG. 2, and various elements of these figures are referenced in explaining the exemplary method. Each block shown in FIG. 7 represent one or more processes, methods, or subroutines carried out in the exemplary method 700. Furthermore, the illustrated order of blocks is illustrative only and the order of the blocks can be changed. The exemplary method 700 can begin at block 41. Depending on the embodiment, additional blocks can be utilized and the ordering of the blocks can be changed.

At block 41, a detection module detects whether the control system is activated, when the control system is activated, the detection module sends a signal of the control system being activated to a control module.

At block 42, a control module controls the camera to extend outwardly from the electronic device to enter into a working state in response to the signals received from the detection module.

At block 43, a setting module presets a rotation angle and generates rotation angle commands to control the camera to rotate the preset rotation angle, after the camera being in a working state.

At block 44, a control module receives the rotation angle commands, controls the camera to rotate through the preset rotation angle and to capture images.

After the block 44, the exemplary method 700 can include a procedure (not shown in the FIG. 7): if the control module determines that the target in the captured images is moving, and control module controls the camera to rotate to track the target according to the relative movement of the target in the images; if the control module determines that the target in the captured images is not moving, the procedure goes to block 45. At block 45, a sending module generates a signal of the control system being closed when the control system is closed, and sends the signal of the control system being closed to the control module.

At block 46, a control module controls the camera to stop working and retract into the electronic device in response to the signal of the control system being closed.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device comprising:
a display device;
at least one processor coupled to the display device;
a rotatable and retractable camera coupled to the at least one processor; and
a storage device storing one or more programs, which when executed by the at least one processor of the electronic device causes the at least one processor to:
send, when the control system is activated, a signal of the control system being activated;
control the camera to extend outwardly from the electronic device in response to the signal of the control system being activated, thereby entering into a working state; and
generate, according to a preset rotation angle, rotation angle commands to control the camera rotate.

2. The electronic device according to claim 1, wherein the rotation angle is set through a user interface in accordance with the control system displayed on the display device.

3. The electronic device according to claim 1, wherein when the display device displays images captured by the camera, the display device displays a small size user interface in accordance with the control system.

4. The electronic device according to claim 1, wherein the rotation angle commands is generated based on voice from the user.

5. The electronic device according to claim 1, wherein the processor generates corresponding control commands by analyzing a predetermined gesture in the images captured by the camera.

6. The electronic device according to claim 1, wherein the processor generates commands to control the camera to rotate by analyzing a relative movement of a target in the images.

7. The electronic device according to claim 6, wherein when the control system is closed, the at least one processor controls the camera to stop working and to be retracted into the electronic device.

8. A computer-implemented method for controlling being executed by at least one processor of an electronic device, the electronic device having a display device, a rotatable and retractable camera, a storage device, the method comprising:
sending, when the control system is activated, a signal of the control system being activated;
controlling the camera to extend outwardly from the electronic device in response to the signal of the control system being activated, thereby entering into a working state; and
generating, according to a preset rotation angle, rotation angle commands to control the camera rotate.

9. The method according to claim 8, wherein the rotation angle is set through a user interface in accordance with the control system displayed on the display device.

10. The method according to claim 8, wherein when the display device displays images captured by the camera, the display device displays a small size user interface in accordance with the control system.

11. The method according to claim 8, wherein the rotation angle commands is generated based on voice from the user.

12. The method according to claim 8, wherein the processor generates corresponding control commands by analyzing a predetermined gesture in the images captured by the camera.

13. The method according to claim 8, wherein the processor generates commands to control the camera to rotate by analyzing a relative into movement of a target in the images.

14. The method according to claim 13, wherein when the control system is closed, the at least one processor controls the camera to stop working and to be retracted the electronic device.

15. A non-transitory storage medium having stored thereon instructions that, when executed by at least one processor of an electronic device, causes the at least one processor to perform a method for controlling a controlled device, the electronic device comprising a touch panel, wherein the method comprises:
sending, when the control system is activated, a signal of the control system being activated;
controlling the camera to extend outwardly from the electronic device in response to the signal of the control system being activated, thereby entering into a working state;
generating, according to a preset rotation angle, rotation angle commands to control the camera rotate; and
when the control system is closed, the at least one processor controls the camera to stop working and to be retracted into the electronic device.

16. The non-transitory storage medium according to claim 15, wherein the rotation angle is set through a user interface in accordance with the control system displayed on the display device.

17. The non-transitory storage medium according to claim 15, wherein when the display device displays images captured by the camera, the display device displays a small size user interface in accordance with the control system.

18. The non-transitory storage medium according to claim 15, wherein the rotation angle commands is generated based on voice from the user.

19. The non-transitory storage medium according to claim 15, wherein the processor generates corresponding control commands by analyzing a predetermined gesture in the images captured by the camera.

20. The non-transitory storage medium according to claim 15, wherein the processor generates commands to control the camera to rotate by analyzing a relative movement of a target in the images.
